(19) United States
(12) Patent Application Publication
(10) Pub. No.: US 2008/0305396 A1
(43) Pub. Date: Dec. 11, 2008

(54) Lead-acid battery expanders with improved life at high temperatures

(76) Inventor: David Paul Boden, Charlottesville, VA (US)

Correspondence Address: Patula & Associates, P.C., 14th Floor, 116 S. Michigan Ave., Chicago, IL, 60603, US

(21) Appl. No.: 11/810,659

(22) Filed: Jun. 6, 2007

(51) Int. Cl. H01M 4/88; H01M 4/58

(52) U.S. Cl. 429/231.4; 252/182.1; 29/623.1

(57) ABSTRACT

An expander formulation for use in a battery paste incorporates an organic component or lignosulfonate characterized by improved resistance to high temperature degradation. Battery plates made from battery pastes which incorporate this expander formulation exhibit considerable improvements in the life of the batteries, especially at high battery operating temperatures. The organic component preferably is a purified, partially desulfonated, high molecular weight sodium lignosulfonate made from softwood.

### FIELD OF INVENTION

The present disclosure relates generally to expanders used in battery pastes, and to processes for producing battery plates. In particular, expander formulations for use in battery pastes and processes for producing negative plates for lead acid batteries are disclosed. More specifically, the present disclosure comprises one or more expander formulations incorporating an organic component or lignosulfonate characterized by improved resistance to high temperature degradation. As a result, the lead-acid batteries incorporating the negative plates made from the disclosed expander formulations exhibit considerable improvements to the life of the batteries, especially at high battery operating temperatures.

### BACKGROUND OF THE INVENTION

The manufacture of battery plates for lead-acid batteries generally involves a paste mixing, curing and drying operation in which the active materials in the battery paste undergo chemical and physical changes that are used to establish the chemical and physical structure and subsequent mechanical strength necessary to form the battery plate. To produce typical battery plates, materials are added to commercial paste mixing machines in the order of lead oxide, water and sulfuric acid, which are then mixed to a paste consistency. Depending on whether negative or positive plates for the batteries are being produced, conventional additives such as a flock or expander may also be used to modify the properties of the paste and the performance of the plates produced. Other additives may be used to enhance or improve the chemical and physical structure and performance of the battery plates, such as the additive disclosed in U.S. Pat. No. 7,118,830 issued to Boden et al. on Oct. 10, 2006, the entire disclosure of which is herein incorporated by reference.

The negative plates of lead-acid batteries are usually produced by preparing a paste with an expander additive, and then applying this battery paste to electrically conducting lead alloy structures known as grids to produce plates. Typically, these pasted plates are then cured in heated chambers containing air with a high relative humidity. This curing process produces the necessary chemical and physical structure required for subsequent handling and performance in the battery. Following curing, the plates are dried using any suitable means. These plates, comprising negative active material, are then suitable for use in the battery.

The expander, which is usually a mixture of barium sulfate, carbon, and a lignosulfonate or other organic material, is added to the negative plate active material during preparation of the paste. The expander materials can be added separately to the paste during the paste mixing process, but an improved procedure is to mix the constituent materials of the expander before adding them to the paste mix.

The expander performs a number of functions in the negative plate, which will be briefly described. The function of the barium sulfate is to act as a nucleating agent for lead sulfate produced when the plate is discharged. The lead sulfate discharge product deposits on the barium sulfate particles assuring homogeneous distribution throughout the active material and preventing coating of the lead particles. It is desirable that the barium sulfate crystals have a very small particle size, of the order of 1 micron or less, so that a very large number of small seed crystals are implanted in the negative active material. This ensures that the lead sulfate crystals, which are growing on the barium sulfate nuclei, are small and of a uniform size so that they are easily converted to lead active material when the plate is charged.

The carbon increases the electrical conductivity of the active material in the discharged state, which improves its charge acceptance. The carbon is usually in the form of carbon black, activated carbon and/or graphite.

The function of the lignosulfonate is more complex. It is chemically adsorbed on the lead active material resulting in a significant increase in its surface area. Without lignosulfonate, the surface area is of the order of approximately 0.2 square meters per gram while, with 0.50% of lignosulfonate, this is increased to approximately 2 square meters per gram. This high surface area increases the efficiency of the electrochemical process which improves the performance of the negative plate. The lignosulfonate also stabilizes the physical structure of the negative active material, which retards degradation during operation of the battery. This property increases the life of the battery in service.

A widely recognized problem with expanders is that the organic component is deactivated at high battery operating temperatures. Consequently, batteries that are used in high ambient temperatures have a shorter life than those operating in temperate climates. This is clearly shown in FIG. 1 which shows the results of a survey of automotive lead-acid battery lifetimes carried out in various regions of the Unites States. It is easily seen in FIG. 1 that batteries used in the southern, hotter regions of the United States have shorter lives than those used in the northern, cooler regions of the United States. For example, the graph in FIG. 1 shows that after 48 months in service, only approximately 40% of automotive batteries used in northern regions of the United States failed, while approximately 67% of automotive batteries used in southern regions of the United States failed. After 60 months, only approximately 60% of batteries used in northern regions of the United States failed, while close to 85% of batteries used in southern regions of the United States failed.

An additional factor causing batteries to have a shorter life is that under-the-hood temperatures in automobiles are increasing as cars become smaller and as more heat-generating equipment is added. The growing use of automobiles in tropical climates adds to this problem. Further, batteries frequently encounter high temperatures during their initial charging in the manufacturing operation. Temperatures exceeding 70° C. are common. This also contributes to degradation of the organic component in the expander.

Consequently, a need exists for improvements in battery pastes and plates that have improved resistance to degradation at high temperatures. The present disclosure overcomes the above identified disadvantages and/or shortcomings of known prior art expanders, battery pastes and methods for producing negative battery plates, and provides a significant improvement thereover.

### SUMMARY OF THE INVENTION

The present disclosure relates to improved expander formulations used in battery paste compositions. The improved expander formulations incorporate an organic component or lignosulfonate characterized by improved resistance to high temperature degradation. Thus, the negative battery plates made from battery pastes which incorporate the improved expander formulations exhibit considerable improvements in the life of the batteries, especially at high battery operating temperatures. Preferably, the organic component used according to the present disclosure is a purified, partially desulfonated, high molecular weight sodium lignosulfonate made from softwood.

Accordingly, an object of the present disclosure is to provide an improved expander formulation incorporating an organic component or lignosulfonate characterized by improved resistance to high temperature degradation.

Another object of the present disclosure is to provide a battery paste composition incorporating the improved expander formulation which exhibits considerable improvements in the life of batteries subjected to relatively high temperatures.

Yet another object of the present disclosure is to provide lead-acid batteries with negative plates having resistance to thermal degradation at high battery operating temperatures.

Yet another object of the present disclosure is to provide lead-acid batteries with negative plates having resistance to thermal degradation when batteries are formed (charged) at high temperatures.

Yet another object of the present disclosure is to provide an improved expander formulation resulting in a negative battery plate which provides equivalent or improved electric performance to conventional lignosulfonates in standard battery industry tests, for example, Cold Cranking Amperes tests, Reserve Capacity tests, and SAE J240 and SAE J2185 cycling tests.

Numerous other objects, features and advantages of the present disclosure will become readily apparent from the detailed description and from the claims which follow.

### BRIEF DESCRIPTION OF THE DRAWINGS

FIG. 1 is a graph illustrating the results of a survey of automotive lead-acid battery lifetimes carried out in various regions of the United States.

FIG. 2 is a table illustrating improved expander formulations and addition rates of the preferred embodiment of the present disclosure for flooded electrolyte automotive batteries.

FIG. 3 is a table illustrating improved expander formulations and addition rates of the preferred embodiment of the present disclosure for flooded electrolyte industrial motive power batteries.

FIG. 4 is a table illustrating improved expander formulations and addition rates of the preferred embodiment of the present disclosure for flooded electrolyte telecommunications batteries.

FIG. 5 is a table illustrating improved expander formulations and addition rates of the preferred embodiment of the present disclosure for flooded electrolyte uninterruptible power supply batteries.

FIG. 6 is a table illustrating improved expander formulations and addition rates of the preferred embodiment of the present disclosure for valve-regulated batteries.

FIG. 7 is a table illustrating battery life testing data from an SAE J240 Life Cycles test at forty-one degrees Celsius (41° C.).

FIG. 8 is a table illustrating battery life testing data from an SAE J240 Life Cycles test at seventy-five degrees Celsius (75° C.).

FIG. 9 is a table illustrating battery life testing data from an SAE 2185 Life Cycles test at fifty degrees Celsius (50° C.).

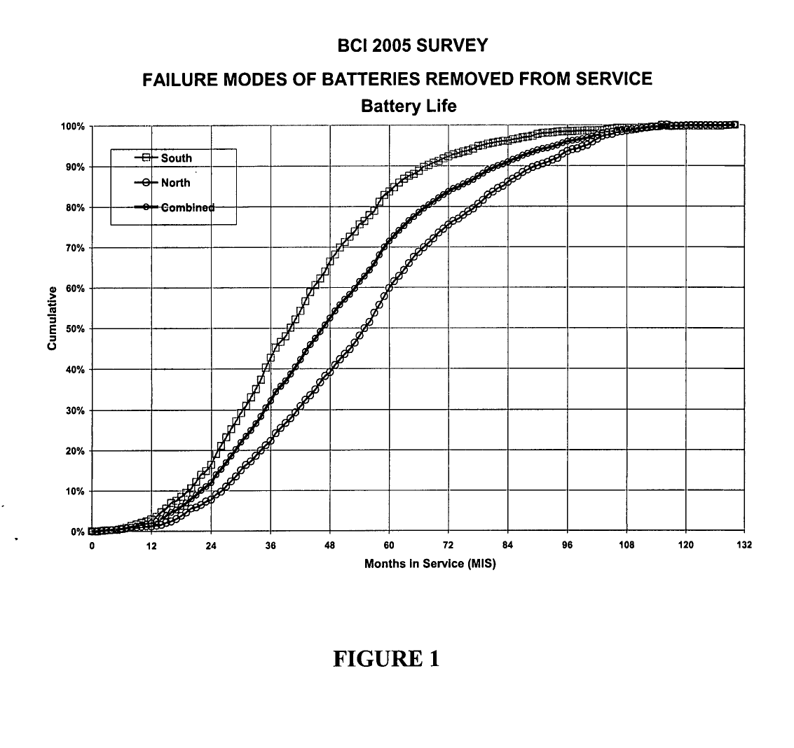

### DETAILED DESCRIPTION OF THE PREFERRED EMBODIMENT

While the present disclosure is susceptible of embodiment in many different forms, there will be described herein in detail, preferred and alternate embodiments of the present disclosure. It should be understood however, that the present disclosure is to be considered an exemplification of the principles of the invention and is not intended to limit the spirit and scope of the invention and/or claims of the embodiments illustrated.

Lead-acid batteries are used in a variety of applications, including but not limited to automobiles, forklift trucks and standby power systems. In addition, these batteries may be of the flooded-electrolyte or valve regulated designs. These various batteries require different proportions of the expander components and different addition rates to the negative active material to give the optimum performance and life. Expanders can be generally classified according to the application, for example: automotive, industrial motive power and industrial standby power. These expanders may also be subdivided for flooded and valve regulated battery designs.

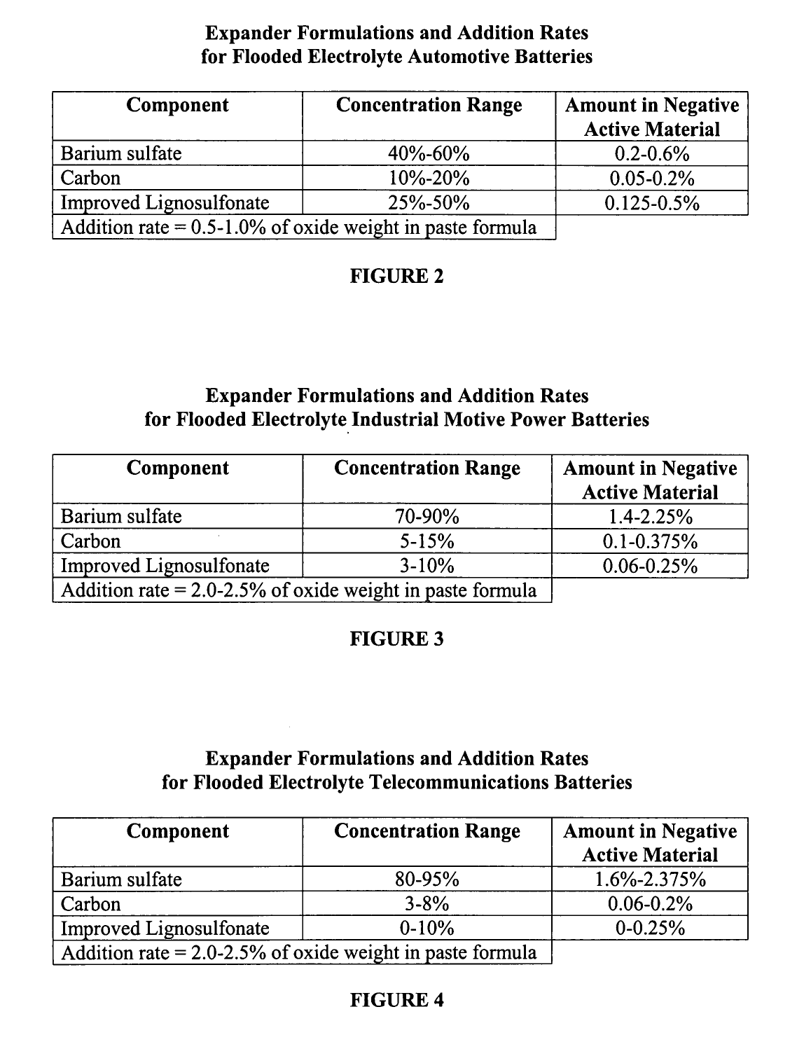

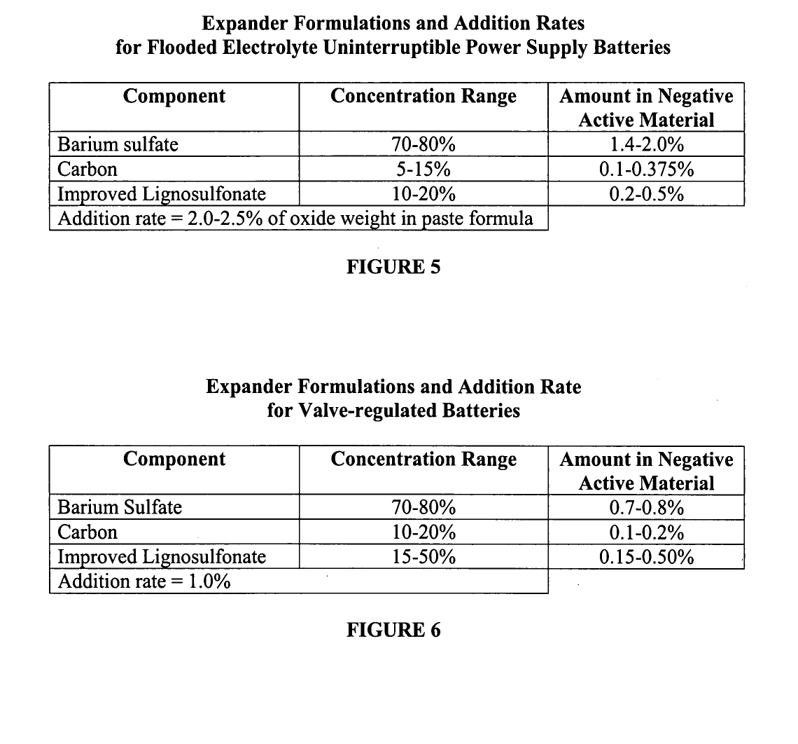

By way of illustration, the improved expander formulations of the present disclosure will be described herein with respect to five specific types of lead-acid batteries, namely, Flooded Electrolyte Automotive Batteries (FIG. 2); Flooded Electrolyte Industrial Motive Power Batteries (FIG. 3); Flooded Electrolyte Telecommunications Batteries (FIG. 4); Flooded Electrolyte Uninterruptible Power Supply Batteries (FIG. 5); and Valve-regulated Batteries (FIG. 6). However, it should be understood that the present disclosure is applicable to any type of batteries which uses an expander in the battery paste mix to form the negative battery plates.

With respect to FIG. 2, the expander formulations for Flooded Electrolyte Automotive Batteries comprise barium sulfate (40-60% concentration range), carbon (10-20% concentration range), and an organic material in the form of a lignosulfonate (25-50% concentration range). These expander materials are added to the battery paste at an addition rate of 0.5-1.0% of oxide weight in the paste mix. The amount of these expander materials in the resulting negative active material is 0.2-0.6% barium sulfate, 0.05-0.2% carbon, and 0.125-0.5% lignosulfonate.

With respect to FIG. 3, the expander formulations for Flooded Electrolyte Industrial Motive Power Batteries comprise barium sulfate (70-90% concentration range), carbon (5-15% concentration range), and an organic material in the form of a lignosulfonate (3-10% concentration range). These expander materials are added to the battery paste at an addition rate of 2.0-2.5% of oxide weight in the paste mix. The amount of these expander materials in the resulting negative active material is 1.4-2.25% barium sulfate, 0.1-0.375% carbon, and 0.06-0.25% lignosulfonate.

With respect to FIG. 4, the expander formulations for Flooded Electrolyte Telecommunications Batteries comprise barium sulfate (80-95% concentration range), carbon (3-8% concentration range), and an organic material in the form of a lignosulfonate (0-10% concentration range). These expander materials are added to the battery paste at an addition rate of 2.0-2.5% of oxide weight in the paste mix. The amount of these expander materials in the resulting negative active material is 1.6-2.375% barium sulfate, 0.06-0.2% carbon, and 0-0.25% lignosulfonate.

With respect to FIG. 5, the expander formulations for Flooded Electrolyte Uninterruptible Power Supply Batteries comprise barium sulfate (70-80% concentration range), carbon (5-15% concentration range), and an organic material in the form of a lignosulfonate (10-20% concentration range). These expander materials are added to the battery paste at an addition rate of 2.0-2.5% of oxide weight in the paste mix. The amount of these expander materials in the resulting negative active material is 1.4-2.0% barium sulfate, 0.1-0.375% carbon, and 0.2-0.5% lignosulfonate.

With respect to FIG. 6, the expander formulations for Valve-regulated Batteries comprise barium sulfate (70-80% concentration range), carbon (10-20% concentration range), and an organic material in the form of a lignosulfonate (15-50% concentration range). These expander materials are added to the battery paste at an addition rate of 1.0% of oxide weight in the paste mix. The amount of these expander materials in the resulting negative active material is 0.7-0.8% barium sulfate, 0.1-0.2% carbon, and 0.15-0.50% lignosulfonate.

It should be recognized that these formulas represent general ranges for expander mixtures and for the concentrations of their components in the negative active material and are not intended to limit the spirit or scope of the present disclosure. The term barium sulfate represents both blanc fixe and barytes forms of this compound and mixtures thereof in particle sizes from 0.5 to 5 micrometers. Carbon represents either carbon black, activated carbon or graphite and mixtures thereof. The organic material can be any lignosulfonate compound or other suitable organic material that can be adsorbed on the surface of the negative active material and thereby affect its surface area and electrochemical behavior. It is also understood that other materials such as wood flour and soda ash are sometimes added to expanders. These may be added to the expander formulas in FIGS. 2-6 without materially changing the spirit or scope of the present disclosure.

The improved expander compositions and materials in FIGS. 2-6 incorporate a lignosulfonate with improved resistance to high temperature degradation, as opposed to a conventional lignosulfonate which is prone to temperature degradation. Preferably, this lignosulfonate with improved resistance to high temperature degradation is a purified, partially desulfonated, high molecular weight sodium lignosulfonate made from softwood. One such lignosulfonate is commercially available under the trade name Vanisperse HT-1 from Borregaard-Lignotech located in Sarpsborg, Norway. However, it should be understood that any similar lignosulfonate or other organic material which is resistant to high temperature degradation could be used. Additionally, a combination or mixture of such an improved, high temperature resistant lignosulfonate and other conventional lignosulfonates can be used together in the improved expander compositions. These improved expander compositions may be used in automotive, industrial motive power and standby power batteries of both the flooded and valve-regulated designs.

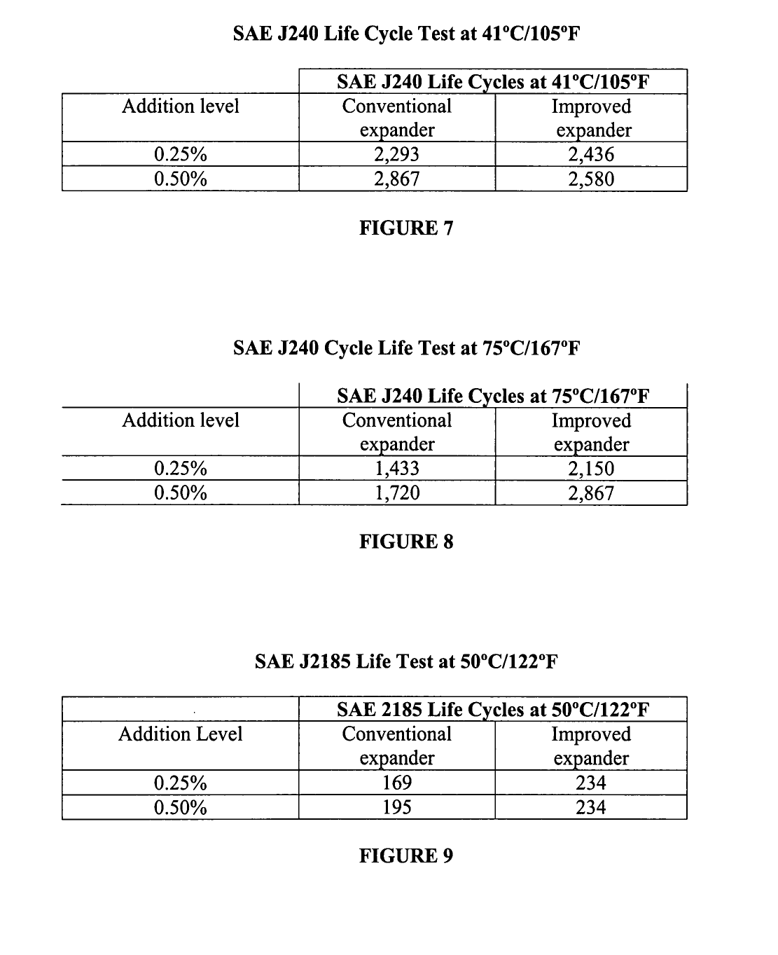

As examples of the beneficial properties of these improved expander compositions, test data from automotive battery testing is illustrated in FIGS. 7-9. As shown in FIG. 2, expanders suitable for automobile batteries have concentrations of organic material in the range of 25%-50% of the expander. These expanders are used at an addition rate between 0.50%-1.0% of the lead oxide in the negative paste resulting in a concentration range of organic material in the range 0.125%-0.5% in the plates. The choice of the exact concentration of organic material within the designated range depends on such factors as the desired battery performance, its operating temperature and required life. When a purified, partially desulfonated, high molecular weight sodium lignosulfonate made from softwood is substituted for a conventional organic compound or lignosulfonate in a typical automotive battery expander, considerable improvements to the life of the batteries is obtained.

FIGS. 7-9 show a comparison of automotive battery life testing data from automotive batteries produced with the improved expander formulation, and automotive batteries produced with conventional expander formulations, showing test data for three life cycles tests (FIGS. 7-9 respectively) using two industry standard tests (SAE J240 and SAE J2185). Two different addition levels of the amount of lignosulfonate in the negative active material (0.25% and 0.5%) were evaluated.

It can be seen in FIG. 7 that in the Society of Automotive Engineers (SAE) J240 life test carried out at 41° C., there is little difference between the life of batteries using the conventional expander and those with the improved expander. At the 0.25% level, the battery with the conventional expander had 2,293 life cycles compared to 2,436 life cycles for the battery with the improved expander. At the 0.50% level, the battery with the conventional expander had 2,867 life cycles compared to 2,580 life cycles for the battery with the improved expander. Thus, at a relatively moderate temperature of 41° C., batteries with both the conventional expander and the improved expander gave similar performances.

When the temperature is increased to 75° C., as shown in FIG. 8, the number of cycles obtained from the battery with the conventional expander is reduced from 2,293 to 1,433 (a 37.5% decrease) at the 0.25% level and from 2,867 to 1,720 (a 40% decrease) at the 0.50% level. However, there is relatively little change in the cycles achieved in the battery with the improved expander, i.e., from 2,436 to 2,150 (an 11.7% decrease) at the 0.25% level and from 2,580 to 2,867 (an 11.1% increase) at the 0.50% level. Thus, at the elevated temperature of 75° C., the batteries with the improved expander performed significantly better than those with the conventional expander.

In the SAE J2185 test at 50° C., as shown in FIG. 9, the conventional expander gave 169 life cycles with 0.25% dosage or amount, and 195 life cycles with 0.5% dosage or amount. On the other hand, the improved expander gave 234 cycles at both dosage levels. This data shows the improved high temperature characteristics of the improved expander containing the purified, partially desulfonated, high molecular weight sodium lignosulfonate made from softwood, i.e., a 38.5% improvement over the conventional expander at the 0.25% addition level, and a 20% improvement over the conventional expander at the 0.5% additional level.

These tests show the benefits of the improved expander material over the conventional material at high operating temperatures. Similar benefits can be obtained when the improved expander material is used in other applications such as motive power and standby power batteries. These benefits will also be obtained when the improved expander material is used in valve-regulated batteries. Improved expanders for batteries designed for automobile starting, motive power, telecommunications and uninterruptible power supplies can be improved to give superior high temperature durability by use of formulas as shown in FIGS. 2-5, while improved expander formulations for valve-regulated batteries are shown in FIG. 6.

The foregoing specification describes only the preferred embodiment and alternate embodiments of the disclosure. Other embodiments besides the above may be articulated as well. The terms and expressions therefore serve only to describe the disclosure by example only and not to limit the disclosure. It is expected that others will perceive differences, which while differing from the foregoing, do not depart from the spirit and scope of the disclosure herein described and claimed.

What is claimed is:

1. An expander for a battery paste comprising:
barium sulfate;
carbon; and
an organic material;
wherein the organic material is characterized as being resistant to thermal degradation.

2. The expander of claim 1, wherein the organic material is lignosulfonate.

3. The expander of claim 2, wherein the lignosulfonate is a purified, partially desulfonated, high molecular weight sodium lignosulfonate made from softwood.

4. The expander of claim 1, wherein the organic material increases the life cycle of a battery having a battery plate made from the battery paste with the expander at temperatures above 41° C.

5. A battery paste incorporating the expander of claim 1.

6. A battery plate made from the battery paste of claim 5.

7. A method for producing battery paste, comprising the steps of:
formulating a battery paste mix;
adding to the battery paste mix, separately or premixed, barium sulfate, carbon, and an organic material;
wherein the organic material is resistant to thermal degradation.

8. The method of claim 7, wherein the organic material is lignosulfonate.

9. The method of claim 8, wherein the lignosulfonate is a purified, partially desulfonated, high molecular weight sodium lignosulfonate made from softwood.

10. The method of claim 7, wherein the organic material increases the life cycle of a battery having a battery plate made from the battery paste with the expander at temperatures above 41° C.

11. A battery paste made from the method of claim 7.

12. A battery plate made from the battery paste of claim 11.

13. An expander for a battery paste comprising:
barium sulfate;
carbon;
a first organic material; and
a second organic material characterized as being resistant to thermal degradation.

14. The expander of claim 13, wherein the second organic material is a lignosulfonate.

15. The expander of claim 14, wherein the lignosulfonate is a purified, partially desulfonated, high molecular weight sodium lignosulfonate made from softwood.

16. The expander of claim 13, wherein the second organic material increases the life cycle of a battery having a battery plate made from the battery paste with the expander at temperatures above 41° C.

17. A battery paste incorporating the expander of claim 13.

18. A battery plate made from the battery paste of claim 17.
